(19) United States
(12) Patent Application Publication
(10) Pub. No.: US 2025/0049062 A1
(43) Pub. Date: Feb. 13, 2025

(54) PROCESS FOR THE PRODUCTION OF A LIQUID COFFEE EXTRACT PRODUCT

(71) Applicant: Koninklijke Douwe Egberts B.V., Utrecht (NL)

(72) Inventors: Maarten Juriaan Verhoeven, Utrecht (NL); Maria Hendrika Meerman, Utrecht (NL); Ellen Roos, Utrecht (NL); Joannes Hubertus Petrus Maria Smits, Utrecht (NL); Jack Rees, Utrecht (NL)

(21) Appl. No.: 18/723,036

(22) PCT Filed: Dec. 20, 2022
(86) PCT No.: PCT/EP2022/086973

§ 371 Date: Jun. 21, 2024

(30) Foreign Application Priority Data
Dec. 24, 2021 (GB) 2118988.1

(51) Int. Cl. A23F 5/24; A23F 5/26; A23F 5/50

(52) U.S. Cl. CPC A23F 5/243; A23F 5/262; A23F 5/505

(57) ABSTRACT

The present invention relates to a process for the production of a liquid coffee extract product, the process comprising the steps of: a) subjecting roast and ground coffee to an extraction step to produce a high aromatic coffee extract and a low aromatic coffee extract; and b) combining the low aromatic coffee extract with the high aromatic coffee extract to form a liquid coffee extract product; wherein the method further comprises a step of raising the pH of the low aromatic coffee extract to no more than pH 5.5; and wherein the low aromatic coffee extract is maintained at a temperature of less than 110° C. before step b). The present invention also relates to a liquid coffee extract product comprising 4-O-caffeoyl-muco-γ-quinide in an amount of at least 20, 21, 22, 23, 24, 25, 26, 27, 28, 29 or at least 30 mg/kg dry matter of the coffee product after storage in chilled conditions for 6 months.

### TECHNICAL FIELD OF THE INVENTION

The present invention relates to a process for the production of a liquid coffee extract product that has improved storage stability at chilled and ambient temperatures.

### BACKGROUND TO THE INVENTION

Liquid coffee extract products, such as liquid coffee concentrates, are increasingly in demand for commercial and/or industrial purposes. The production and sales of liquid coffee extract products, e.g. liquid coffee concentrates for use in coffee dispensing machines, makes it desirable to provide liquid coffee that has a sufficient shelf-life. Up to now, such liquid coffee extract products are mostly available in a frozen form, and sometimes refrigerated. Non-refrigerated storage would decrease supply chain costs. However, most products sold for non-refrigerated storage still have an undesirably short shelf-life.

Generally speaking, a liquid coffee extract product (such as a concentrate or an extract) is unstable over time and becomes increasingly acidic at room temperature. As is known by the skilled man, the pH drop might be due to microbial action and to chemical reaction, such as a slow hydrolysis reaction of some compounds such as esters and lactones, oxidation of carbonyl group containing compounds or even the Maillard reaction occurring among polysaccharides and proteins. A pH of 4.8 is commonly considered in literature as the lower limit for taste acceptability. Below that pH level the coffee extract becomes undrinkable. To overcome microbial acidification the liquid coffee is often treated by UHT (Ultra High Temperature). Particularly suitable UHT treatment is at 120° C. for a couple of seconds.

A reference addressing the shelf life of liquid coffees is EP 1 374 690. Herein a coffee extract is subjected, essentially immediately after preparation, to correction of acidity by the addition of a base or an anion resin to raise the pH to above 5.5. The resulting extract is subjected to pasteurisation. The pasteurisation is discussed with reference to holding times and temperatures that do not affect the organoleptic properties of the coffee extract. A typical temperature range is 100° C.-140° C. at a holding time of at most 1 minute. This method fails also to produce products of sufficient shelf-life and quality.

Another reference addressing the stabilization of liquid coffee is EP1182936. This reference may be treated to account for or reduce the formation of acids during storage. This may be done by the addition of alkali or an ion exchange. Usually, the pH is raised to above 9. This method fails to produce products of sufficient shelf-life and quality.

The object of the present invention is to provide a process with which an improvement of the storage of the liquid coffee extract product, together with an improvement in flavour and quality is achieved.

It is also an object of the present invention to provide a liquid coffee extract product which can be stored under chilled and/or ambient conditions without a noticeable reduction in flavour or quality

It is also an aim of embodiments of the invention to overcome at least one problem of the prior art, whether expressly disclosed herein or not.

### SUMMARY OF THE INVENTION

According to a first aspect of the present invention, there is provided a process for the production of a liquid coffee extract product, the process comprising the steps of:
a) subjecting roast and ground coffee to an extraction step to produce a high aromatic coffee extract and a low aromatic coffee extract; and
b) combining the low aromatic coffee extract with the high aromatic coffee extract to form a liquid coffee extract product;
wherein the method further comprises a step of raising the pH of the low aromatic coffee extract to no more than pH 5.5; and wherein the low aromatic coffee extract is maintained at a temperature of less than 110° C. before step b).

It has been surprisingly found that the elevation of the pH of the liquid coffee extract product prevents deterioration due to the release of bound acids during storage under chilled and ambient conditions. The elevation in pH accounts for or reduces the formation of acids during storage. Beneficially, this allows the liquid coffee extract product to have a shelf life of greater than 6 months, without any pronounced impact on the aroma.

Moreover, it has been surprisingly found that the elevation of the pH of the liquid coffee extract product to no more than 5.5 prevents an imbalance in the aroma profile. Without being bound by theory, it is thought that there is a relation between the pH of coffee and the partitioning of aroma compounds between the gaseous (headspace above the cup) and liquid phase (in the brew). For example, the inventors found that increasing the pH of the coffee extract product to above 5.5 decreased the concentration of 2-Furfurylthiol (roasty note) in the headspace leading to the coffee being perceived as flatter. On the other hand, aroma compounds such as pyridine (fish-like note) show the reverse effect. In other words, an increase in pH above 5.5 has been observed to increase the concentration of pyridine in the headspace resulting in the perception of an off-flavor.

Therefore, surprisingly the inventor's discovered that raising the pH to no more than 5.5 leads to a reduction in the imbalance in the aroma profile and a better sensorial quality of the resulting product.

It has also been surprisingly found that maintaining the temperature at less than 110° C. before step b) improves the quality of the liquid coffee extract product and reduces the costs and energy requirements of the manufacturing process.

Surprisingly, the inventors found that since the pH is raised to no more than pH 5.5 in the pH raising step, the low aromatic coffee extract product does not need to undergo thermal treatment at temperatures of above 110° C. to release bound acids. This has been observed to improve the taste and quality of the liquid coffee concentrate.

The process may further comprise a step of concentrating the low aromatic coffee extract to form a low aromatic coffee extract concentrate.

The step of concentrating the low aromatic coffee extract may be performed after step a) and before step b).

In this embodiment step b) comprises combining the low aromatic coffee extract concentrate with the high aromatic coffee extract to form a liquid coffee extract product.

A concentrate is distinguished from an extract by having undergone a substantial water removing step such as water evaporation. The low aromatic coffee concentrate will generally have a dry matter solids content of at least 4% by weight, preferably from 4 to 75% by weight, more preferably from 10 to 60% by weight. In some embodiments of the present invention, the low aromatic coffee concentrate may have a dry matter solids content of from 15 to 40% by weight. In other embodiments of the present invention, the low aromatic coffee concentrate may have a dry matter solids content of 50 to 60% by weight.

The process of the present invention may further comprise the step of combining part of the low aromatic coffee extract with the high aromatic coffee extract to form a mixture; and a further step of adding the mixture to the remaining low aromatic coffee extract.

In an embodiment wherein the process comprises the step of concentrating the low aromatic coffee extract, the process may further comprise the step of combining part of the low aromatic coffee extract concentrate with the high aromatic coffee extract to form a mixture; and a further step of adding the mixture to the remaining low aromatic coffee extract concentrate.

The inventors surprisingly discovered that combining at least a part of the low aromatic coffee extract or low aromatic coffee extract concentrate with the high aromatic coffee extract to form a mixture allows the high aromatic extract to be held for longer periods of time without negative quality effects.

Typically, in existing processes the high aromatic extract is combined back with the low aromatic coffee extract or the low aromatic coffee extract concentrate without mixing with the low aromatic coffee extract or low aromatic coffee extract concentrate. As such, if the low aromatic coffee extract or low aromatic coffee extract concentrate is subjected to further processing steps, such as centrifugation and/or pH treatment, and the high aromatic coffee extract is stored for a prolonged period of time, the high aromatic coffee extract may develop negative qualities which would then be observed in the coffee extract or coffee concentrate upon combining the high aromatic extract back with the low aromatic coffee extract or low aromatic coffee extract concentrate.

Moreover, the formation of the mixture allows the high aromatic extract to be combined back with the low aromatic coffee extract or the low aromatic coffee extract concentrate without compromising the concentration of the low aromatic coffee extract or the low aromatic coffee extract concentrate. For example, by forming the mixture, the low aromatic coffee extract or the low aromatic coffee extract concentrate is diluted minimally upon adding back the mixture, since the mixture already comprises a part of the low aromatic coffee extract or the low aromatic coffee extract concentrate.

At least 1 wt. %, 2 wt. %, 3 wt. %, 4 wt. %, 5 wt. %, 6 wt. %, or 7 wt. % of the low aromatic coffee extract or low aromatic coffee extract concentrate may be combined with the high aromatic coffee extract to form the mixture in step c). In some embodiments, no more than 40 wt. %, 35 wt. %, 30 wt. %, 25 wt. %, 20 wt. %, 15 wt. % or 10 wt. % of the low aromatic coffee extract or low aromatic coffee extract concentrate may be combined with the high aroma coffee extract to form the mixture.

Preferably 2 to 40 wt. %, more preferably 5 to 40 wt. %, more preferably 5 to 25 wt. %, more preferably 5 to 15 wt. %, most preferably 10 wt. % of the low aromatic coffee extract or low aromatic coffee extract concentrate is combined with the high aroma coffee extract to form the mixture.

The mixture may have a ratio of low aromatic coffee extract or low aromatic coffee extract concentrate to high aromatic coffee extract of at least 0.2:1, 0.3:1, 0.35:1, 0.4:1 or 0.5:1. In some embodiments, the ratio of low aromatic coffee extract or low aromatic coffee extract concentrate to high aromatic coffee extract may be no more than 1:1, 0.9:1, 0.8:1, 0.7:1, or 0.6:1.

Preferably the mixture has a ratio of low aromatic coffee extract or low aromatic coffee extract concentrate to high aromatic coffee extract of 0.35:1 to 0.7:1, more preferably 0.4:1 to 0.65:1, more preferably 0.5:1 to 0.6:1, most preferably 0.55:1.

The above ratios may be the mass ratio of coffee solids in the low aromatic coffee extract or low aromatic coffee extract concentrate to the high aromatic coffee extract.

The high aromatic coffee extract may be stored before and/or after formation of the mixture.

Generally, the step of combining the remaining low aromatic coffee extract or low aromatic coffee extract concentrate with the mixture of the low aromatic coffee extract or low aromatic coffee extract concentrate and the high aromatic coffee extract is done in the factory before optionally further treatment steps and packaging.

In the factory, after temporary, preferably cooled, storage, preferably below 10° C., the mixture may directly, without further processing, be added to the low aromatic coffee extract or low aromatic coffee extract concentrate. It is preferred that the mixture is stored as briefly as possible and cooled, for adding to the low aromatic coffee extract or low aromatic coffee extract concentrate; owing to these steps loss of aroma and aroma degradation reactions are limited as much as possible.

The step of raising the pH may raise the pH to no more than 5.4, 5.2, 5.3, 5.2, 5.1, 5.0, 4.9, 4.8, or 4.7. In some embodiments, the step of raising the pH may raise the pH to at least 4.5, 4.6, 4.7, 4.8, 4.9, or 5.0.

The step of raising the pH may raise the pH 4.5 to 5.5, 4.6 to 5.5, 4.7 to 5.5, 4.8 to 5.5, 4.9 to 5.5, or 5.0 to 5.5.

The pH of the low aromatic coffee extract and/or low aromatic coffee extract concentrate may be raised by at least 0.1, 0.2, 0.3, 0.4, 0.5, or 0.6. In some embodiments the pH of the coffee extract and/or coffee extract concentrate may be raised by no more than 0.8, 0.7, 0.6, or 0.5.

The pH of the low aromatic coffee extract and/or low aromatic coffee extract concentrate may be raised by 0.1 to 0.8, 0.1 to 0.7, 0.1 to 0.6, 0.1 to 0.5, or 0.1 to 0.4 units higher than original pH.

This raise is relative to the starting pH. i.e., if the starting pH is 4, the pH rise could be to a value that is still acidic, e.g. 5. However, preferably the starting pH of the coffee stream is 4.5 to 5.5, more preferably from 4.8 to 5.5.

The titratable acidity of the low aromatic coffee extract and/or low aromatic coffee concentrate may be raised by no more than 250 mmol/kg, 225 mmol/kg, 200 mmol/kg, 175 mmol/kg 150 mmol/kg, 140 mmol/kg, 130 mmol/kg, 120 mmol/kg, 110 mmol/kg, 105 mmol/kg, 100 mmol/kg, 95 mmol/kg, 90 mmol/kg, or 85 mmol/kg in the pH raising step. In some embodiments the titratable acidity of the low aromatic coffee extract and/or low aromatic coffee concentrate may be raised by at least 40 mmol/kg, 50 mmol/kg, 60 mmol/kg, 65 mmol/kg, 70 mmol/kg, 75 mmol/kg, 80 mmol/kg or 85 mmol/kg.

The titratable acidity may be raised 40 to 250 mmol/kg, 40 to 225 mmol/kg, 40 to 200 mmol/kg, 40 to 175 mmol/kg, 40 to 150 mmol/kg, 40 to 140 mmol/kg, 40 to 130 mmol/kg, 40 to 120 mmol/kg, 40 to 110 mmol/kg, 50 to 110 mmol/kg, 60 to 110 mmol/kg, preferably 70 to 110 mmol/kg.

“Titratable acidity” is used herein to refer to the total acid concentration of the low aromatic coffee extract and/or low aromatic coffee concentrate measured in mmol/kg of dry coffee matter.

Surprisingly, the inventors found that a lower degree of de-acidification prevents imbalances in the aroma profile.

The pH may be raised using any suitable procedure.

In one embodiment of the present invention, an alkali may be added to the low aromatic coffee extract and/or low aromatic coffee extract concentrate to raise the pH.

The alkali may be selected from the group consisting of sodium hydroxide, calcium hydroxide, potassium hydroxide and sodium bicarbonate.

Alternatively, the pH raising step is conducted without adding alkali.

Beneficially, by avoiding the addition of foreign substances, it is secured that the product after treatment remains considered to be “coffee” in accordance with the applicable food legislation in many jurisdictions. For, in such jurisdictions the addition of substances other than those obtained from the extraction will result in a product that is not allowed to be indicated as a coffee. It will be understood that such a product may receive a different perception by consumers.

Preferably, the pH raising step is carried out using an ion exchange process.

Beneficially, the use of an ion exchange process means that no additives are added to the low aromatic coffee extract and/or low aromatic coffee extract concentrate.

In such an embodiment, preferably the pH raising step is conducted without adding alkali.

The ion exchange process may be carried out by the addition of an ion exchange resin and/or an adsorber.

The adsorber may be carbon based, polyacrylate based or polystyrene based. Examples of commercial adsorbers include Purolite® MN 200, Purolite® MN 202, and Lewatit® AF5.

The ion exchange resins may be a strong or weak basic anion exchange resin. Preferably, the ion exchange resin is a weak basic anion exchange resin.

The resin may be based on polyacrylate or polystyrene.

Preferably the resin is based on polyacrylate.

The resin may have one or more amine functional groups. The amine functional group may be a primary, tertiary, and quaternary amine groups as well as polyamine groups. Preferably, the amine functional group is a tertiary amine.

Examples of commercial ion exchange resins are listed in the following table:

| | | gel/ | | total |
|---|---|---|---|---|
| | | macro- | | capacity |
| Name | Matrix | porous | functional group | (eq/L) |
| Rohm & | polyacrylic | gel | tertiary amine | 1.6 |
| Haas IRA | | | | |
| 67 | | | | |
| Novasep ® | | | | |
| XA 945 | | | | |
| Lewatit ® | polystyrene | macro- | tertiary amine | 1.7 |
| MP 62 | | porous | | |
| Purolite ® | polystyrene | gel | tertiary amine | 1.2 |
| A 172 | | | | |
| Lewatit ® A | polyacrylic | gel | poly amine | |
| 365 | | | | |
| Lewatit ® | polystyrene | gel | poly amine | 2.9 (3.4) |
| VP OC | | | | |
| 1075 | | | | |
| Lewatit ® | polystyrene | macro- | primary amine | 2.2 |
| VP OC | | porous | | |
| 1065 | | | | |
| Lewatit ® | polystyrene | gel | quaternary amine, | 1.2 |
| MonoPlus | | | Type I | |
| M 500 | | | | |
| Lewatit ® | polystyrene | gel | quaternary amine, | 1.1 |
| M 600 | | | Type II | |
| Dowex ® | styrene- | gel | quaternary | 1.2 |
| 1X8 | divinylbenzene | | ammonium | |
| chloride | | | | |
| form | | | | |
| Amberlite | polystyrene- | gel | quaternary | 1.30 |
| IRA405 Cl | divinylbenzene | | ammonium | |
| Amberlite | styrene- | gel | dimethyl- | 1.25 |
| IRA410 Cl | divinylbenzene | | ethanolammonium | |
| Amberlite | Acrylic | gel | quaternary | 1.25 |
| IRA458 Cl | | | ammonium | |
| Amberlite | Acrylic | gel | quaternary | 0.80 |
| IRA958 Cl | | | ammonium | |
| Dowex 66 | styrene- | macro- | tertiary amine | 1.6 |
| free base | divinylbenzene | porous | | |
| Amberlite ® | styrene- | macro- | polyamine | 1.25 |
| IRA-96 free | divinylbenzene | porous | | |
| base | | | | |
| Diaion ® | styrene- | highly | tertiary amine | 1.5 (3.0) |
| WA30 free | divinylbenzene | porous | | |
| base | | | | |
| Diaion ® | styrene- | porous | tertiary/quaternary | 1.3 |
| WA55 free | divinylbenzene | | ammonium | |
| base | | | | |
| QAE | dextran | | diethyl-(2-hydroxy- | 2.6 (3.4) |
| Sephadex | | | propy)aminoethyl | |
| A25 | | | | |
| Capto Q | Highly cross- | | quaternary | 1.6 |
| | linked agarose | | ammonium | |

At least 50 wt. %, 60 wt. %, 70 wt. %, 80 wt. %, or 90 wt. % of the low aromatic coffee extract and/or low aromatic coffee concentrate may be subjected to the pH raising step. In some embodiments, no more than 98 wt. %, 95 wt. %, 90 wt. %, 85 wt. %, or 80 wt. % of the low aromatic coffee extract and/or low aromatic coffee concentrate may be subjected to the pH raising step.

Preferably 60 to 98 wt. %, more preferably 70 to 98 wt. %, most preferably 85 to 95 wt. % of the low aromatic coffee extract and/or low aromatic coffee concentrate is subjected to the pH raising step.

The coffee chosen for the extraction in step a) can be any type of roasted coffee. The provision of roasted coffee is well-known to the skilled person. E.g., the starting material can be a customary coffee bean raw material for industrial extraction processes, which coffee origins are roasted in the customary manner. As a rule, to that end, a mixture of different types of coffee origins is used. The roasted coffee beans are ground, while generally, for the degree of grinding a compromise is sought between obtaining the largest possible surface and obtaining a lowest possible pressure drop across the extraction cell. The ground beans may have an average size of 2.0 millimetres.

In order to better preserve coffee aromas, the pH raising step of the present invention is conducted on the low aromatic coffee extract and/or low aromatic coffee extract concentrate. This is obtained by a) subjecting roasted, ground coffee to one or more extraction steps with water resulting in a coffee extract, separating the coffee extract (i.e., subjecting the coffee extract to separation), either by fractionation during the extraction step(s) in a) or by aroma recovery after step a) resulting in a high aromatic coffee extract and a low aromatic coffee extract.

The skilled person will understand that separation by fractionation results in a fractionated collection of the extract, and that other separation methods, or combinations of, e.g., fractionated collection of the extract and aroma recovery, can be employed. Examples of aroma recovery after step a) include steam stripping, supercritical CO2 extraction, and pervaporation.

Preferably, the coffee extract is fractionated during the extraction step a). The specific coffee aroma, present in the high aromatic coffee extract resulting therefrom, has a more natural coffee character compared to coffee aroma recovered by means of steam stripping from the complete extract after step a). A high aromatic coffee extract and a low aromatic coffee extract are obtained. As known to a skilled person, a high aromatic coffee extract distinguishes itself from a low aromatic coffee extract by having a comparably high amount of volatile flavour compounds compared to semi volatile flavour compounds. Such compounds are known for example from Clarke R. J. and Vitzthum O. G., Coffee Recent Developments, 2001 (ISBN 0-632-05553-7), p. 71, table 3.3. From this table it is clear that on the one hand propanal, methyl propanal, and 2,3 butanedione are measurable volatile flavour compounds. Pyrazine compounds and guaiacol compounds on the other hand are semi volatile flavour compounds.

Taking 2,3-butanedione as an example of a volatile coffee flavour compound and guaiacol, 4 ethyl guaiacol and 2-acetylpyrazine as an example of a semi volatile coffee flavour compound, the wt:wt ratio of the volatile coffee flavour compounds and semi volatile coffee flavour compounds can be used to characterise the high and low aromatic coffee extracts.

The wt:wt ratio of 2,3-butandione:guaiacol in the low aromatic coffee extract may be no more than 1:1, 0.9:1, 0.8:1, 0.7:1, 0.6:1, 0.5:1, 0.4:1, or no more than 0.3:1.

The wt:wt ratio of 2,3-butandione:guaiacol in the low aromatic coffee extract may be from 0.06:1-0.3:1, 0.07:1-0.29:1, 0.08:1-0.28:1, 0.09:1-0.27:1, 0.10:1-0.26:1, or from 0.11:1-0.25:1.

The wt:wt ratio of 2,3-butandione:guaiacol in the high aromatic extract may be at least 2:1, 3:1, 4:1, 5:1, 6:1, 7:1, 8:1, 9:1, 10:1.

The wt:wt ratio of 2,3-butandione:guaiacol in the high aromatic extract may be from 2.10:1-12.90:1, 2.20:1-12.80:1, 2.30:1-12.70:1, 2.40:1-12.60:1, or from 2.44:1-12.59:1.

The wt:wt ratio of 2,3-butandione:guaiacol in the mixture of low aromatic coffee extract and high aromatic extract may be at least 2:1, 3:1, 4:1, 5:1, 6:1, 7:1, 8:1, 9:1, 10:1, 11:1, 12:1, 13:1, 14:1, or at least 15:1.

The wt:wt ratio of 2,3-butandione:guaiacol in the mixture of low aromatic coffee extract and high aromatic extract may be from 2.50:1-18.90:1, 2.60:1-18.80:1, 2.70:1-18.70:1, 2.75:1-18.60:1 or from 2.76:1-18.60:1.

The wt:wt ratio of 2,3-butandione: 4-ethylguaiacol in the low aromatic coffee extract may be no more than 2:1, 1.9:1, 1.8:1, 1.7:1, 1.6:1, 1.5:1, 1.4:1, 1.3:1, 1.2:1, 1.1:1, 1:1, 0.9:1, 0.8:1, 0.7:1, 0.6:1, 0.5:1, 0.4:1, or no more than 0.3:1.

The wt:wt ratio of 2,3-butandione: 4-ethylguaiacol in the low aromatic coffee extract may be from 0.20:1-1.70:1, 0.25:1-1.65:1, 0.30:1-1.60:1, 0.35:1-1.55:1, or from 0.37:1-1.51:1.

The wt:wt ratio of 2,3-butandione: 4-ethylguaiacol in the high aromatic coffee extract may be at least 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1.

The wt:wt ratio of 2,3-butandione: 4-ethylguaiacol in the high aromatic coffee extract may be from 2.30:1-28.0:1, 2.40:1-27.95:1, 2.50:1-27.90:1, 2.60:1-27.85:1, or from 2.62:1-27.83:1.

The wt:wt ratio of 2,3-butandione: 4-ethylguaiacol in the mixture of low aromatic coffee extract and high aromatic extract may be at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, or at least 40:1.

The wt:wt ratio of 2,3-butandione: 4-ethylguaiacol in the mixture of low aromatic coffee extract and high aromatic extract may be from 2.70:1-43.50:1, 2.75:1-43.40:1, 2.80:1-43.30:1, 2.85:1-43.20:1, 2.90:1-43.10:1, 2.95:1-43.05:1, or from 2.97:1-43.04:1.

The wt:wt ratio of 2,3-butandione: 2-acetylpyrazine in the low aromatic coffee extract may be no more than 1:1, 0.9:1, 0.8:1, 0.7:1, 0.6:1, 0.5:1, 0.4:1, or no more than 0.3:1.

The wt:wt ratio of 2,3-butandione: 2-acetylpyrazine in the low aromatic coffee may be from 0.1:1-0.7:1, 0.15:1-0.65:1, 0.20:1-0.60:1 or from 0.25:1-0.60:1.

The wt:wt ratio of 2,3-butandione: 2-acetylpyrazine in the high aromatic coffee extract may be at least 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, or at least 28:1.

The wt:wt ratio of 2,3-butandione: 2-acetylpyrazine in the high aromatic coffee extract may be from 10:1-30:1, 11:1-30:1, 12:1-30:1, 12.1:1-29.9:1, 12.2:1-29.8:1,12.3:1-29.7:1.

The wt:wt ratio of 2,3-butandione: 2-acetylpyrazine in the mixture of low aromatic coffee extract and high aromatic extract may be from 17.00:1-35.70:1, 17.05:1-35.65:1, 17.10:1-35.60:1, 17.15:1-35.55:1, 17.20:1-35.50:1, 17.25:1-35.45:1, or from 17.27:1-35.45:1.

The Extraction step to produce a high aromatic coffee extract and a low aromatic coffee extract may be any suitable method known to the person skilled in the art. Extraction steps to produce a high aromatic coffee extract and a low aromatic coffee extract are well known in the coffee production field. The process may further comprise one or more pasteurization steps to reduce microbial growth in the liquid coffee extract product.

The pasteurisation step may involve a heat treatment.

The heat treatment may be conducted at a temperature of from 60° C. to 120° C. at a holding time of 1 to 100 seconds. The heat treatment may be conducted at a temperature of from 60° C. to 95° C. for a holding time of from 20 to 70 seconds. The heat treatment may be conducted at a temperature of from 100 to 120° C. for a holding time of from 1 to 5 seconds.

The process may further comprise the step of chilling the liquid coffee extract product to a temperature of less than 6° C. Preferably, the step of chilling the liquid coffee concentrate reduces the temperature of the concentrate to 4 to 6° C.

The step of chilling the liquid coffee extract product may be performed by any suitable refrigeration method known in the art.

Surprisingly, it has been observed that liquid coffee extract product formed by the process of the present invention may be stored as a chilled product without negative quality effects. In such a way, the process of the present invention is able to provide a chilled liquid coffee extract product which can be stored for a period of time with no substantial difference when compared to an existing frozen liquid coffee extract product stored for the same period of time. Beneficially, this means that a liquid coffee extract product produced by a process of the present invention may be suitable for use in a chilled supply chain, thereby improving customer convenience.

The process may further comprise the addition of customary liquid or dried filler components may also be added. A filler component is sometimes used to neutralize the marked flavour character of the first primary extract to some extent. The filler is preferably a high yield coffee product. It may be added to the low aromatic coffee extract and/or low aromatic coffee extract concentrate before or after the pH raising step.

According to a second aspect of the present invention, there is provided a liquid coffee extract product having a pH of no more than 5.5, obtainable by a process according to the first aspect of the present invention.

The liquid coffee extract product may be a liquid coffee concentrate.

Surprisingly, the inventors found that a liquid coffee extract product obtainable by a process of the present invention has an improved shelf life and can be stored at ambient temperature (generally indicating a temperature of 5° C. to 25° C., and preferably without the need for refrigerating equipment) without spoiling for at least 6 months.

The inventors also discovered a liquid coffee extract product obtainable by a process of the present invention has an improved shelf life and can be stored at chilled temperatures (generally indicating a temperature of 4° C. to 6° C.) without spoiling for at least 6 months.

The liquid coffee extract product may have a shelf-life in ambient conditions of at least 6, 7, 8, 9, 10, 11, 12, 13, 14, 15, 16, 17 or 18 months.

The liquid coffee extract product may have a shelf-life in chilled conditions of at least 6, 7, 8, 9, 10, 11, 12, 13, 14, 15, 16, 17 or 18 months.

By “shelf-life” it is meant the period of time in which the liquid coffee extract product may be stored without noticeable detriment to the sensory profile. More specifically, the term “shelf-life” may refer to the period of time in which the liquid coffee extract product may be stored without substantial acidification occurring.

The liquid coffee extract product may comprise 4-O-caffeoyl-muco-γ-quinide.

In such an embodiment, the amount of 4-O-caffeoyl-muco-γ-quinide in the coffee extract product may be at least 20, 21, 22, 23, 24, 25, 26, 27, 28, 29, 30 mg/kg dry matter of the coffee product after storage in chilled conditions for 6 months.

By chilled conditions it is meant storage at a temperature of between 2 and 8° C.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69 or from 30-68 mg/kg dry matter of the coffee product after storage in chilled conditions for 6 months.

The amount of 4-O-caffeoyl-muco-γ-quinide in the coffee extract product may be at least 20, 21, 22, 23, 24, 25, 26, 27, 28, 29, 30 mg/kg dry matter of the coffee product after storage in chilled conditions for 9 months.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69, 30-68, 30-67, 30-66, 30-65, 30-64, 30-63, 30-62, 30-61, 30-60, 30-59, 30-58, 30-57, 30-56, 30-55, 30-54, 30-53, 30-52 or from 30-51 mg/kg dry matter of the coffee product after storage in chilled conditions for 9 months.

The amount of 4-O-caffeoyl-muco-γ-quinide in the coffee extract product may be at least 20, 21, 22, 23, 24, 25, 26, 27, 28, 29, 30 mg/kg dry matter of the coffee product after storage in chilled conditions for 12 months.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69, 30-68, 30-67, 30-66, 30-65, 30-64, 30-63, 30-62, 30-61, 30-60, 30-59, 30-58, 30-57, 30-56, 30-55, 30-54, 30-53, or from 30-52 mg/kg dry matter of the coffee product after storage in chilled conditions for 12 months.

Surprisingly, the inventors found that the coffee product obtainable by the process of the present invention had much higher levels of 4-O-caffeoyl-muco-γ-quinide throughout storage. The inventors found that the higher levels of 4-O-caffeoyl-muco-γ-quinide act as a bitter-tasting ingredient. This preserves the required bitter taste of the coffee product throughout storage and contributes to the improved shelf life of the coffee product.

The liquid coffee extract product may comprise 6 wt. % to 80 wt. % coffee solids (i.e. dry matter), preferably 10 wt. % to 65 wt. %, more preferably 15 wt. % to 50 wt. %.

The liquid coffee extract product may be suitable for storage in ambient conditions. In such an embodiment, the liquid coffee extract product may be stored at a temperature of from 5° C. to 25° C.

In such an embodiment, the liquid coffee extract product of the present invention may be stored in ambient conditions without a noticeable reduction in the sensory profile of the liquid coffee extract product.

The liquid coffee extract product may be suitable for storage in chilled conditions. In such an embodiment, the liquid coffee extract product may be stored at a temperature of from 2° C. to 8° C., preferably from 4° C. to 6° C.

In such an embodiment, the liquid coffee extract product of the present invention may be stored in chilled conditions without a noticeable reduction in the sensory profile of the liquid coffee extract product.

The liquid coffee extract product may be packaged in any suitable packaging, for example, a pouch, bag, carton or bottle.

According to a further aspect of the present invention, there is provided a liquid coffee extract product comprising 4-O-caffeoyl-muco-γ-quinide, wherein the amount of 4-O-caffeoyl-muco-γ-quinide in the coffee product is at least 20 mg/kg dry matter of the coffee product after storage in chilled conditions for 6 months.

By chilled conditions it is meant storage at a temperature of between 2° C. to 8° C.

The amount of 4-O-caffeoyl-muco-γ-quinide in the coffee product may be at least 21, 22, 23, 24, 25, 26, 27, 28, 29, or at least 30 mg/kg dry matter of the coffee product after storage in chilled conditions for 6 months.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69 or from 30-68 mg/kg dry matter of the coffee product after storage in chilled conditions for 6 months.

In a still further aspect of the present invention, there is provided a liquid coffee extract product comprising 4-O-caffeoyl-muco-γ-quinide, wherein the amount of 4-O-caffeoyl-muco-γ-quinide in the coffee product is at least 20 mg/kg dry matter of the coffee product after storage in chilled conditions for 9 months.

The amount of 4-O-caffeoyl-muco-γ-quinide in the coffee extract product may be at least 21, 22, 23, 24, 25, 26, 27, 28, 29, 30 mg/kg dry matter of the coffee product after storage in chilled conditions for 9 months.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69, 30-68, 30-67, 30-66, 30-65, 30-64, 30-63, 30-62, 30-61, 30-60, 30-59, 30-58, 30-57, 30-56, 30-55, 30-54, 30-53, 30-52 or from 30-51 mg/kg dry matter of the coffee product after storage in chilled conditions for 9 months.

In a still further aspect of the present invention, there is provided a liquid coffee extract product comprising 4-O-caffeoyl-muco-γ-quinide, wherein the amount of 4-O-caffeoyl-muco-γ-quinide in the coffee product is at least 20 mg/kg dry matter of the coffee product after storage in chilled conditions for 12 months.

The amount of 4-O-caffeoyl-muco-γ-quinide in the coffee extract product may be at least 20, 21, 22, 23, 24, 25, 26, 27, 28, 29, 30 mg/kg dry matter of the coffee product after storage in chilled conditions for 12 months.

The amount of 4-O-caffeoyl-muco-γ-quinide in the coffee extract product may be from 30-80, 30-79, 30-78, 30-77, 30-76, 30-75, 30-74, 30-73, 30-72, 30-71, 30-70, 30-69, 30-68, 30-67, 30-66, 30-65, 30-64, 30-63, 30-62, 30-61, 30-60, 30-59, 30-58, 30-57, 30-56, 30-55, 30-54, 30-53, or from 30-52 mg/kg dry matter of the coffee product after storage in chilled conditions for 12 months.

The inventors found that a coffee product comprising elevated levels of 4-O-caffeoyl-muco-γ-quinide after 6, 9 or 12 months storage showed improved taste and had an improved shelf life.

According to a further aspect of the present invention, there is provided a process for the production of a liquid coffee concentrate, the process comprising the steps of:
a) subjecting roast and ground coffee to an extraction step to produce a high aromatic coffee extract and a low aromatic coffee extract;
b) concentrating said low aromatic coffee extract to produce a low aromatic coffee extract concentrate; and
c) combining a part of the low aromatic coffee extract concentrate with the high aroma coffee extract to form a mixture;
d) adding the mixture to the remaining low aromatic coffee extract concentrate;
wherein the method further comprises a step of raising the pH of the low aromatic coffee extract and/or low aromatic coffee extract concentrate to no more than pH 5.5.

The temperature of the low aromatic coffee extract and/or low aromatic coffee extract concentrate and/or liquid coffee concentrate may be maintained at a temperature of less than 110° C. throughout the process steps a), b), c) and d).

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only, with reference to the accompanying examples and drawings, of which:

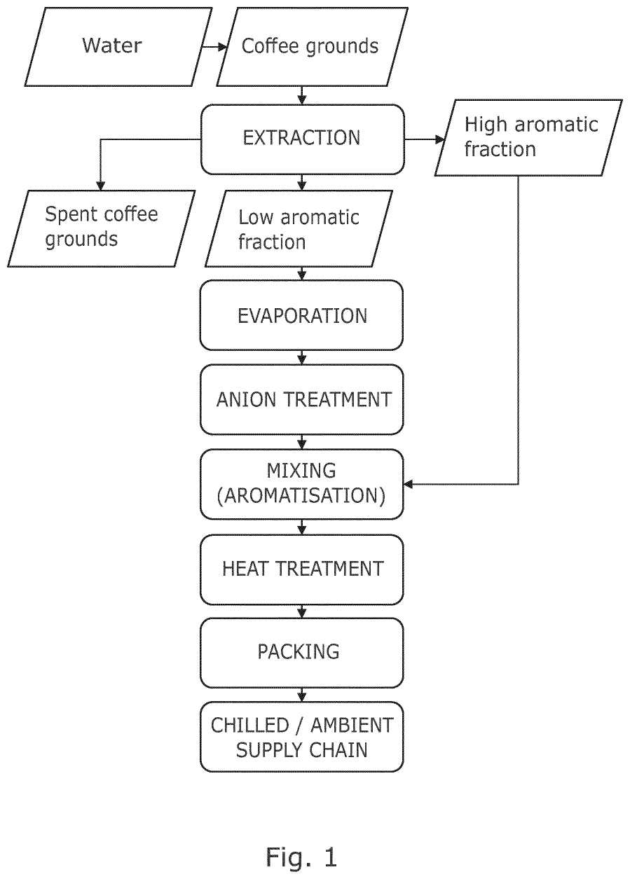

FIG. 1: shows a process scheme of a preferred embodiment of the present invention.

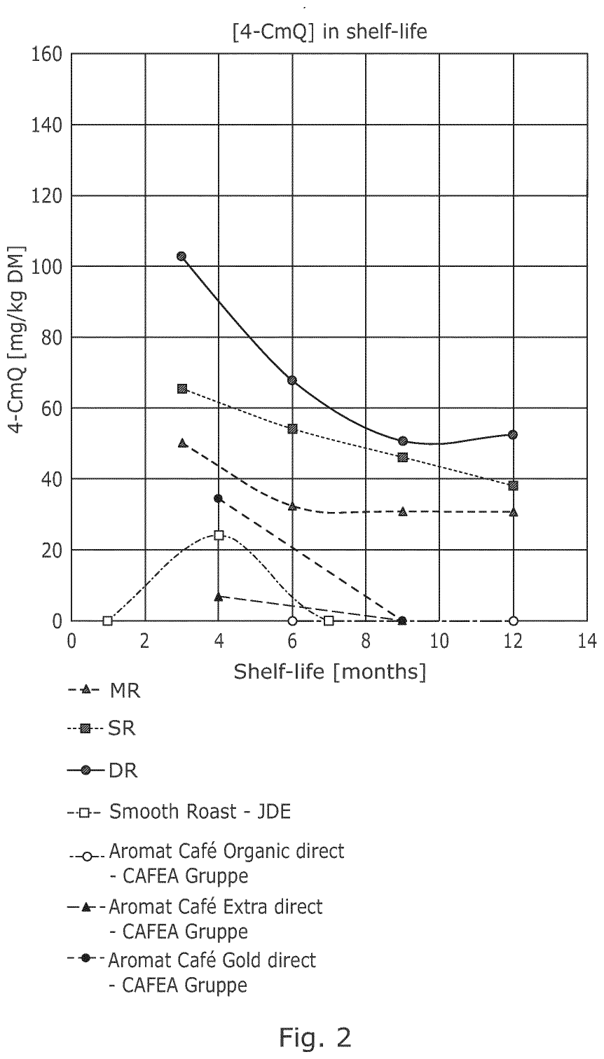

FIG. 2: shows a chart comparing the concentration of 4-O-caffeoyl-muco-γ-quinide (4-CmQ) in products of the present invention and existing products.

A preferred embodiment of the invention is illustrated in FIG. 1. A roasted coffee is subjected to extraction rendering a high aromatic coffee extract and a low aromatic coffee extract. The low aromatic extract is then subjected to evaporation to form a low aromatic coffee extract concentrate. The low aromatic coffee extract concentrate is subjected to pH adjustment (by anion exchange). The low aromatic coffee extract concentrate is then combined with the high aromatic extract to form a liquid coffee concentrate of the present invention.

### Reference Example 1

### Extraction

From a single batch of roast and ground coffee comprising 100% robusta coffee beans, a high aromatic coffee extract and a low aromatic coffee extract is obtained by packed bed column extraction.

### Evaporation

The low aromatic coffee extract is concentrated by use of a mechanical vapour recompression (MVR) or thermal vapour recompression (TVR) evaporator to a dry matter solids content of 58% by evaporation.

### Processing

The low aromatic coffee extract concentrate was then diluted to a dry matter solids content of 33% and subject to centrifugation.

### Aroma Addback

The high aroma coffee extract was recombined with the low aromatic coffee extract concentrate to form a liquid coffee concentrate.

### Final Product

The resulting liquid coffee concentrate had a pH of 5.01.

No detectable off flavour was detected in the liquid coffee concentrate.

During a shelf life of 12 months at a storage temperature of −20° C. the pH of the liquid coffee concentrate was 4.93.

After 3 months, 6 months, 9 months and 12 months the liquid coffee concentrate was not perceived as acidified by a team of sensory experts. The sample was used as a comparative sensory reference for examples 2-4

### Example 2

### Extraction

From a single batch of roast and ground coffee comprising 100% robusta coffee beans, a high aromatic coffee extract and a low aromatic coffee extract is obtained by packed bed column extraction.

The high aromatic coffee extract had a wt:wt ratio of 2,3-butandione:guiacol of 2.44:1, a wt:wt ratio of 2,3-butandione: 4-ethylguiacol of 2.62:1 and a wt:wt ratio of 2,3-butandione: 2-acetylpyrazine of 22.59:1.

The low aromatic coffee extract had a wt:wt ratio of 2,3-butandione:guiacol of 0.11:1, a wt:wt ratio of 2,3-butandione: 4-ethylguiacol of 0.37:1 and a wt:wt ratio of 2,3-butandione: 2-acetylpyrazine of 0.58:1.

### Evaporation

The low aromatic coffee extract is concentrated by use of an MVR or TVR evaporator to a dry matter solids content of 58% by evaporation.

### Formation of Mixture

Around 10 wt. % of the low aromatic coffee extract concentrate is combined with the high aromatic extract to form a mixture having a ratio of low aromatic coffee extract concentrate to high aromatic coffee extract of 0.55:1.

### Processing

The low aromatic coffee extract concentrate was diluted to a dry matter solids content of 33% and subject to centrifugation.

The pH of the resulting low aromatic coffee extract concentrate was then adjusted from pH 4.99 to 5.27 by passing the concentrate over an anion column (Lewatit® XA 945). The anion column comprised a polyacrylate based ion exchange resin. The titratable acidity of the low aromatic coffee extract concentrate was raised by 72 mmol/kg.

### Aroma Addback

After pH treatment, the mixture formed from the combination of the low aromatic coffee extract concentrate and the high aroma coffee extract is recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 5.20.

No detectable off flavour was detected in the liquid coffee concentrate.

During a shelf life of 12 months at a storage temperature of 4-6° C. the pH of the liquid coffee concentrate was 4.84.

After 3 months, 6 months, 9 months and 12 months the liquid coffee concentrate was not deemed as having a significant sensory difference when compared with the frozen liquid coffee concentrate described in Reference Example 1 by a team of sensory experts. Moreover, the liquid coffee concentrate was not perceived as acidified by a team of sensory experts.

### Example 3

### Extraction

From a single batch of roast and ground coffee comprising 100% robusta coffee beans, a high aromatic coffee extract and a low aromatic coffee extract is obtained by packed bed column extraction.

The high aromatic coffee extract had a wt:wt ratio of 2,3-butandione:guiacol of 2.44:1, a wt:wt ratio of 2,3-butandione: 4-ethylguiacol of 2.62:1 and a wt:wt ratio of 2,3-butandione: 2-acetylpyrazine of 22.59:1.

The low aromatic coffee extract had a wt:wt ratio of 2,3-butandione:guiacol of 0.11:1, a wt:wt ratio of 2,3-butandione: 4-ethylguiacol of 0.37:1 and a wt:wt ratio of 2,3-butandione: 2-acetylpyrazine of 0.58:1.

### Evaporation

The low aromatic coffee extract is concentrated by use of an MVR or TVR evaporator to a dry matter solids content of 58% by evaporation.

### Formation of Mixture

Around 10 wt. % of the low aromatic coffee extract concentrate is combined with the high aromatic extract to form a mixture having a ratio of low aromatic coffee concentrate to high aromatic coffee extract of 0.55:1.

The mixture had a wt:wt ratio of 2,3-butandione:guiacol of 2.76:1, a wt:wt ratio of 2,3-butandione: 4-ethylguiacol of 2.97:1 and a wt:wt ratio of 2,3-butandione: 2-acetylpyrazine of 28.53:1

### Processing

The low aromatic coffee extract concentrate was diluted to a dry matter solids content of 33% and subject to centrifugation.

The pH of the resulting low aromatic coffee extract concentrate was then adjusted from pH 4.99 to 5.38 by passing the concentrate over an anion column (Lewatit® XA 945). The anion column comprised a polyacrylate based ion exchange resin. The titratable acidity of the low aromatic coffee extract concentrate was raised by 94 mmol/kg.

### Aroma Addback

After pH treatment, the mixture formed from the combination of the low aromatic coffee extract concentrate and the high aroma coffee extract is recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 5.22.

No detectable off flavour was detected in the liquid coffee concentrate.

During a shelf life of 12 months at a storage temperature of 4-6° C. the pH of the liquid coffee concentrate was 4.86.

After 3 months, 6 months, 9 months and 12 months the liquid coffee concentrate was deemed to not have a significant sensory difference when compared with the frozen liquid coffee concentrate described in Reference Example 1 by a team of sensory experts. Moreover, the liquid coffee concentrate was not perceived as acidified by a team of sensory experts.

### Example 4

### Extraction

From a single batch of roast and ground coffee comprising 100% robusta coffee beans, a high aromatic coffee extract and a low aromatic coffee extract is obtained by packed bed column extraction.

The high aromatic coffee extract had a wt:wt ratio of 2,3-butandione:guiacol of 2.44:1, a wt:wt ratio of 2,3-butandione: 4-ethylguiacol of 2.62:1 and a wt:wt ratio of 2,3-butandione: 2-acetylpyrazine of 22.59:1.

The low aromatic coffee extract had a wt:wt ratio of 2,3-butandione:guiacol of 0.11:1, a wt:wt ratio of 2,3-butandione: 4-ethylguiacol of 0.37:1 and a wt:wt ratio of 2,3-butandione: 2-acetylpyrazine of 0.58:1.

### Evaporation

The low aromatic coffee extract is concentrated by use of an MVR or TVR evaporator to a dry matter solids content of 58% by evaporation.

### Formation of Mixture

Around 10 wt. % of the low aromatic coffee extract concentrate is combined with the high aromatic extract to form a mixture having a ratio of low aromatic coffee concentrate to high aromatic coffee extract of 0.55:1.

The mixture had a wt:wt ratio of 2,3-butandione:guiacol of 2.76:1, a wt:wt ratio of 2,3-butandione: 4-ethylguiacol of 2.97:1 and a wt:wt ratio of 2,3-butandione: 2-acetylpyrazine of 28.53:1

### Processing

The low aromatic coffee extract concentrate was diluted to a dry matter solids content of 33% and subject to centrifugation.

The pH of the resulting low aromatic coffee extract concentrate was then adjusted from pH 4.99 to 5.49 by passing the concentrate over an anion column (Lewatit® XA 945). The anion column comprised a polyacrylate based ion exchange resin. The titratable acidity of the low aromatic coffee extract concentrate was raised by 116 mmol/kg.

### Aroma Addback

After pH treatment, the mixture formed from the combination of the low aromatic coffee extract concentrate and the high aroma coffee extract is recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 5.28.

No detectable off flavour is detected in the liquid coffee concentrate.

During a shelf life of 12 months at a storage temperature of 4-6° C. the pH of the liquid coffee concentrate was 4.88.

After 3 months, 6 months, 9 months and 12 months the liquid coffee concentrate was deemed to not have a significant sensory difference when compared with the frozen liquid coffee concentrate described in Reference Example 1 by a team of sensory experts. Moreover, the liquid coffee concentrate was not perceived as acidified by a team of sensory experts.

### Reference Example 5

### Extraction

From a single batch of roast and ground coffee comprising 30% arabica and 70% robusta coffee beans, a high aromatic coffee extract and a low aromatic coffee extract is obtained by packed bed column extraction.

### Evaporation

The low aromatic coffee extract is concentrated by use of an MVR or TVR evaporator to a dry matter solids content of 58% by evaporation.

### Processing

The low aromatic coffee extract concentrate was then diluted to a dry matter solids content of 33% and subject to centrifugation.

### Aroma Addback

The high aroma coffee extract was recombined with the low aromatic coffee extract concentrate to form a liquid coffee concentrate.

### Final Product

The resulting liquid coffee concentrate had a pH of 4.96.

No detectable off flavour was detected in the liquid coffee concentrate.

During a shelf life of 12 months at a storage temperature of −20° C. the pH of the liquid coffee concentrate was 4.81.

After 3 months, 6 months, 9 months and 12 months the liquid coffee concentrate was not perceived as acidified by a team of sensory experts. The sample was used as a comparative sensory reference for example 6.

### Example 6

### Extraction

From a single batch of roast and ground coffee comprising 30% Arabica and 70% robusta coffee beans, a high aromatic coffee extract and a low aromatic coffee extract is obtained by packed bed column extraction.

The high aromatic coffee extract had a wt:wt ratio of 2,3-butandione:guiacol of 8.37:1, a wt:wt ratio of 2,3-butandione: 4-ethylguiacol of 11.69:1 and a wt:wt ratio of 2,3-butandione: 2-acetylpyrazine of 29.70:1.

The low aromatic coffee extract had a wt:wt ratio of 2,3-butandione:guiacol of 0.15:1, a wt:wt ratio of 2,3-butandione: 4-ethylguiacol of 0.60:1 and a wt:wt ratio of 2,3-butandione: 2-acetylpyrazine of 0.40:1.

### Evaporation

The low aromatic coffee extract is concentrated by use of an MVR or TVR evaporator to a dry matter solids content of 58% by evaporation.

### Processing

The low aromatic coffee extract concentrate was then diluted to a dry matter solids content of 33% and subject to centrifugation.

The pH of the resulting low aromatic coffee extract concentrate was then adjusted from pH 4.88 to 5.10 by passing the concentrate over an anion column (Lewatit® XA 945). The anion column comprised a polyacrylate based ion exchange resin. The titratable acidity of the low aromatic coffee extract concentrate was raised by 70 mmol/kg.

### Aroma Addback

After pH treatment, the high aromatic coffee extract was recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 5.06.

No detectable off flavour is detected in the liquid coffee concentrate.

During a shelf life of 12 months at a storage temperature of 4-6° C. the pH of the liquid coffee concentrate was 4.81.

After 3 months, 6 months, 9 months and 12 months the liquid coffee concentrate was deemed to not have a significant sensory difference when compared with the frozen liquid coffee concentrate described in Reference Example 5 by a team of sensory experts. Moreover, the liquid coffee concentrate was not perceived as acidified by a team of sensory experts.

### Reference Example 7

### Extraction

From a single batch of roast and ground coffee comprising 100% arabica coffee beans, a high aromatic coffee extract and a low aromatic coffee extract is obtained by packed bed column extraction.

### Evaporation

The low aromatic coffee extract is concentrated by use of an MVR or TVR evaporator to a dry matter solids content of 58% by evaporation.

### Processing

The low aromatic coffee extract concentrate was then diluted to a dry matter solids content of 33% and subject to centrifugation.

### Aroma Addback

The high aroma coffee extract was recombined with the low aromatic coffee extract concentrate to form a liquid coffee concentrate.

### Final Product

The resulting liquid coffee concentrate had a pH of 4.80.

No detectable off flavour was detected in the liquid coffee concentrate.

During a shelf life of 12 months at a storage temperature of −20° C. the pH of the liquid coffee concentrate was 4.68.

After 3 months, 6 months, 9 months and 12 months the liquid coffee concentrate was not perceived as acidified by a team of sensory experts. The sample was used as a comparative sensory reference for Examples 8 and 9.

### Example 8

### Extraction

From a single batch of roast and ground coffee comprising 100% Arabica coffee beans, a high aromatic coffee extract and a low aromatic coffee extract is obtained by packed bed column extraction.

The high aromatic coffee extract had a wt:wt ratio of 2,3-butandione:guiacol of 12.59:1, a wt:wt ratio of 2,3-butandione: 4-ethylguiacol of 27.83:1 and a wt:wt ratio of 2,3-butandione: 2-acetylpyrazine of 12.34:1.

The low aromatic coffee extract had a wt:wt ratio of 2,3-butandione:guiacol of 0.25:1, a wt:wt ratio of 2,3-butandione: 4-ethylguiacol of 1.51:1 and a wt:wt ratio of 2,3-butandione: 2-acetylpyrazine of 0.27:1.

### Evaporation

The low aromatic coffee extract is concentrated by use of an MVR or TVR evaporator to a dry matter solids content of 58% by evaporation.

### Processing

The low aromatic coffee extract concentrate was then diluted to a dry matter solids content of 33% and subject to centrifugation.

The pH of the resulting low aromatic coffee extract concentrate was then adjusted from pH 4.80 to 4.98 by passing the concentrate over an anion column (Lewatit® XA 945). The anion column comprised a polyacrylate based ion exchange resin. The titratable acidity of the low aromatic coffee extract concentrate was raised by 65 mmol/kg.

### Aroma Addback

After pH treatment, the high aromatic coffee extract was recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 4.90.

No detectable off flavour is detected in the liquid coffee concentrate.

During a shelf life of 12 months at a storage temperature of 4-6° C. the pH of the liquid coffee concentrate was 4.68.

After 3 months, 6 months and 9 months the liquid coffee concentrate was deemed to not have a significant sensory difference when compared with the frozen liquid coffee concentrate described in Reference Example 7 by a team of sensory experts. Moreover, the liquid coffee concentrate was not perceived as acidified by a team of sensory experts.

### Example 9

### Extraction

From a single batch of roast and ground coffee comprising 100% Arabica coffee beans, a high aromatic coffee extract and a low aromatic coffee extract is obtained by packed bed column extraction.

The high aromatic coffee extract had a wt:wt ratio of 2,3-butandione:guiacol of 12.59:1, a wt:wt ratio of 2,3-butandione: 4-ethylguiacol of 27.83:1 and a wt:wt ratio of 2,3-butandione: 2-acetylpyrazine of 12.34:1.

The low aromatic coffee extract had a wt:wt ratio of 2,3-butandione:guiacol of 0.25:1, a wt:wt ratio of 2,3-butandione: 4-ethylguiacol of 1.51:1 and a wt:wt ratio of 2,3-butandione: 2-acetylpyrazine of 0.27:1.

### Evaporation

The low aromatic coffee extract is concentrated by use of an MVR or TVR evaporator to a dry matter solids content of 58% by evaporation.

### Formation of Mixture

Around 10 wt. % of the low aromatic coffee extract concentrate is combined with the high aromatic extract to form a mixture having a ratio of low aromatic coffee concentrate to high aromatic coffee extract of 0.55:1.

The mixture had a wt:wt ratio of 2,3-butandione:guiacol of 18.60:1, a wt:wt ratio of 2,3-butandione: 4-ethylguiacol of 43.04:1 and a wt:wt ratio of 2,3-butandione: 2-acetylpyrazine of 17.27:1

### Processing

The low aromatic coffee extract concentrate was diluted to a dry matter solids content of 33% and subject to centrifugation.

The pH of the resulting low aromatic coffee extract concentrate was then adjusted from pH 4.68 to 4.83 by passing the concentrate over an anion column (Lewatit® XA 945). The anion column comprised a polyacrylate based ion exchange resin. The titratable acidity of the low aromatic coffee extract concentrate was raised by 68 mmol/kg.

### Aroma Addback

After pH treatment, the mixture formed from the combination of the low aromatic coffee extract concentrate and the high aroma coffee extract is recombined with the pH treated low aromatic coffee extract concentrate to form a liquid coffee concentrate.

The liquid coffee concentrate was then heat treated for removal of lactobacillus at 77° C. for a holding time of 21 seconds.

### Final Product

The resulting liquid coffee concentrate had a pH of 4.77.

No detectable off flavour is detected in the liquid coffee concentrate.

During a shelf life of 12 months at a storage temperature of 4-6° C. the pH of the liquid coffee concentrate was 4.66.

After 3 months and 6 months the liquid coffee concentrate was deemed to not have a significant sensory difference when compared with the frozen liquid coffee concentrate described in Reference Example 7 by a team of sensory experts. Moreover, the liquid coffee concentrate was not perceived as acidified by a team of sensory experts.

From Examples 2 to 4, 6 and 8 to 9 it can be seen that a liquid coffee concentrate produced by a process of the present invention may be stored under chilled conditions without developing noticeable differences in the sensory profile of the coffee when tested by a team of sensory experts. Therefore, the present process can be seen to provide a liquid coffee concentrate which can be stored under chilled conditions for long periods of time without significant sensory degradation.

In the above examples, the wt:wt ratios of the volatile and semi-volatile compounds in the high aromatic extract, low aromatic extract and mixture of the low aromatic coffee extract and high aromatic extract were determined as follows: 5 g of liquid coffee concentrate and 50 μl of an internal standard solution (comprising 1-methylindole, 1-phenylethanol, 2-ethylbutanal, 4-heptanone, diethyldisulfide, ethylmaltol, ethylvanillin, linalool-d3, propionic-2,2-d2 acid, pyrazine-d4) was suspended in a 5 ml saturated salt solution of Sodium Sulphate (anhydrous) granules. Isolation of the aromas was achieved by Liquid Liquid Extraction of this suspension with 5 ml Methyl Tertiary-Butyl ether (MTBE).

The resulting solution was equilibrated for 30 min at 40° C. in an ultrasonic bath, after which it was centrifuged for 15 minutes at 3000 rpm at 6° C. The supernatant was transferred in an Eppendorf vial and some dry Sodium Sulphate (fine) was added, mixed and allowed to settle for 15 min. This mixture was centrifuged for 10 min at 100000 rpm at 6° C.

The extracted aroma compounds of interest were separated by capillary gas chromatography (Stabilwax DA column: 30 m, ID 0.25 mm and 0.5 μm film (Restek Technologies), injection temperature 40° C., gradual temperature increase of 15° C./min till 250° C.) and detected by mass spectrometry MS-MS in SRM mode. Quantification was achieved using relative response to the internal standard.

As shown in FIG. 2, the coffee products obtained via the process of the present invention have a much higher concentration of 4-O-caffeoyl-muco-γ-quinide (4-CmQ) throughout storage when compared with existing products.

In order to produce the data for FIG. 2, 5-caffeoylquinic acid (5-CQA) was obtained from Sigma-Aldrich and a working solution of approximately 2500 mg/l was obtained by diluting in 20% MeOH/MilliQ water (MQW). This working solution was further diluted with MQW to obtain calibration solutions of 250 and 500 mg/l.

Concentrated coffee products as described below were then diluted with water to 0.1% dry matter solution.

The 4-CmQ in the coffee products were then analysed with HPLC-UV using a Phenyl-Hexyl Luna, 250 mm×4.6 mm, column at 35° C. and detected at 324 nm.

Separation was done by using the eluents MeOH (Eluent A) and Ammonium formate buffer (0.25 mol/l, pH 3.5) (Eluent B) with the program shown in the below table:

| Time | Eluent A | Eluent B |
|---|---|---|
| (min) | (%) | (%) |
| 0 | 25 | 75 |
| 38 | 28 | 72 |
| 44.5 | 100 | 0 |
| 49.5 | 100 | 0 |
| 50 | 25 | 75 |
| 60 | 25 | 75 |

As shown in FIG. 2, a medium roast blend (MR) comprising 30% Arabica and 70% Robusta coffee beans prepared according to Example 6, a strong roast blend (SR) comprising 100% Robusta coffee beans prepared according to Example 3, and a delicate roast blend (DR) comprising 100% Arabica coffee beans prepared via a process according to Example 8, all showed at least 30 mg/kg dry matter coffee solids even after 12 months storage of the product under chilled conditions.

In contrast, the existing products of Aromat Café Extra direct, Aromat Café Gold direct, Aromat Café Organic direct from CAFEA Gruppe, together with a smooth roast blend from Jacobs Douwe Egberts, showed much lower levels of 4-O-caffeoyl-muco-γ-quinide at all storage periods. This led to a perceivable difference in the taste profile over time within each product.

Consequently, the products of the present invention showed improved shelf life and a reduced perceivable difference in the taste profile over time when compared with existing products.

The one or more embodiments are described above by way of example only. Many variations are possible without departing from the scope of protection afforded by the appended claims.

1. A process for the production of a liquid coffee extract product, the process comprising the steps of:
a) subjecting roast and ground coffee to an extraction step to produce a high aromatic coffee extract and a low aromatic coffee extract; and
b) combining the low aromatic coffee extract with the high aromatic coffee extract to form a liquid coffee extract product;
wherein the method further comprises a step of raising the pH of the low aromatic coffee extract to no more than pH 5.5; and wherein the low aromatic coffee extract is maintained at a temperature of less than 110° C. before step b).

2. A process according to claim 1, wherein after step a) and before step b) the process further comprises a step of concentrating the low aromatic coffee extract to produce a low aromatic coffee extract concentrate; and wherein step b) comprises combining the low aromatic coffee extract concentrate with the high aromatic coffee extract to form a liquid coffee extract product.

3. A process as claimed in claim 1, wherein after step a) and before step b) part of the low aromatic coffee extract or low aromatic coffee extract concentrate is combined with the high aromatic coffee extract to form a mixture; and wherein step b) comprises adding the mixture to the remaining low aromatic coffee extract or low aromatic coffee extract concentrate.

4. A process according to claim 3, wherein at least 2 wt. % of the low aromatic coffee extract or the low aromatic coffee extract concentrate is combined with the high aromatic coffee extract to form the mixture.

5. A process according to claim 4, wherein from 2 to 40 wt. % of the low aromatic coffee extract or the low aromatic coffee extract concentrate is combined with the high aromatic coffee extract to form the mixture.

6. (canceled)

7. A process according to claim 3, wherein the mixture has a ratio of low aromatic coffee extract or low aromatic coffee extract concentrate to high aromatic coffee extract of at least 0.2:1.

8. A process according to claim 7, wherein the mixture has a ratio of low aromatic coffee extract or low aromatic coffee extract concentrate to high aromatic coffee extract of from 0.35:1 to 0.7:1.

9. A process according to claim 1, wherein the step of raising the pH may raise the pH from 4.5 to 5.5.

10. (canceled)

11. A process according to claim 1, wherein the step of raising the pH may raise the pH by 0.1 to 0.8.

12. A process according to claim 1, wherein the step of raising the pH comprises raising the titratable acidity of the low aromatic coffee extract and/or low aromatic coffee by no more than 250 mmol/kg.

13. A process according to claim 12, wherein the titratable acidity of the low aromatic coffee extract and/or low aromatic coffee concentrate may be raised by 40 to 340 mmol/kg.

14. A process according to claim 13, wherein the titratable acidity of the low aromatic coffee extract and/or low aromatic coffee concentrate may be raised by 50 to 140 mmol/kg.

15. (canceled)

16. A process according to claim 1, wherein the step of raising the pH is carried out using an ion exchange process.

17. A process according to claim 16, wherein the ion exchange process comprises the addition of an ion exchange resin and/or an adsorber.

18. A process according to claim 17, wherein the ion exchange resin is polyacrylate or polystyrene based.

19. A process according to any proceeding claim 1, wherein at least 50 wt. % of the low aromatic coffee extract and/or low aromatic coffee extract concentrate is subjected to the pH raising step.

20. (canceled)

21. A liquid coffee extract product having a pH of no more than 5.5, obtainable by a process according to claim 1.

22. A product according to claim 21, wherein the liquid coffee extract product is a liquid coffee concentrate.

23. A product according to claim 21, wherein the coffee extract product comprises 4-O-caffeoyl-muco-γ-quinide in an amount of at least 20, 21, 22, 23, 24, 25, 26, 27, 28, 29 or at least 30 mg/kg dry matter of the coffee product after storage in chilled conditions for 6 months.

24. A liquid coffee extract product comprising 4-O-caffeoyl-muco-γ-quinide, wherein the amount of 4-O-caffeoyl-muco-γ-quinide in the coffee product is at least 20, 21, 22, 23, 24, 25, 26, 27, 28, 29 or at least 30 mg/kg dry matter of the coffee product after storage in chilled conditions for 6 months.
